(19) United States
(12) Patent Application Publication
(10) Pub. No.: US 2020/0379377 A1
(43) Pub. Date: Dec. 3, 2020

(54) SECONDARY TRANSFER DEVICE

(71) Applicant: Konica Minolta Inc., Tokyo (JP)

(72) Inventor: Tomoyuki HAYAKAWA, Tokyo (JP)

(21) Appl. No.: 16/869,090

(22) Filed: May 7, 2020

(30) Foreign Application Priority Data
May 27, 2019 (JP) 2019-098283

(51) Int. Cl. G03G 15/16

(52) U.S. Cl. CPC G03G 15/1615

(57) ABSTRACT

A secondary transfer device performs secondary transfer of a toner image onto a paper sheet at a predetermined secondary transfer position, the toner image having been transferred onto an outer peripheral surface of an intermediate transfer belt through primary transfer, the intermediate transfer belt being stretched around a plurality of rollers, the intermediate transfer belt having an endless annular shape and a predetermined width, and the secondary transfer device includes: a pressure releaser that moves a secondary transfer roller between a pressing position and a separate position; a first driver that drives the pressure releaser; a high-speed pressure reducer that temporarily performs pressure reduction on a nip pressure for the secondary transfer roller at the pressing position to press the intermediate transfer belt being nipped between the secondary transfer roller and the counter roller; and a second driver that drives the high-speed pressure reducer.

The entire disclosure of Japanese patent Application No. 2019-098283, filed on May 27, 2019, is incorporated herein by reference in its entirety.

### BACKGROUND

### Technological Field

The present invention relates to a secondary transfer device that performs secondary transfer to transfer a toner image transferred onto an intermediate transfer belt through primary transfer onto a paper sheet, and more particularly, to a secondary transfer device capable of alleviating the impact to be caused when the top and bottom edges of a paper sheet pass through the secondary transfer position.

### Description of the Related Art

In many electrophotographic image forming apparatuses, image formation units of respective colors such as yellow (Y), magenta (M), cyan (C), and black (K) that form toner images in the respective colors are disposed along the outer peripheral surface of an endless annular intermediate transfer belt that has a predetermined width and is stretched around plurality of rollers. The toner images in the respective colors are sequentially superimposed on one another on the intermediate transfer belt by these image formation units, so that a full-color toner image is formed on the intermediate transfer belt, and is transferred (secondary transfer) onto a paper sheet.

At the secondary transfer position, the intermediate transfer is nipped between a roller that supports the intermediate transfer belt from inside, and a secondary transfer roller that is pushed by a spring or the like from outside and presses the intermediate transfer belt. Thus, a transfer nip is formed. When a paper sheet being conveyed passes through the transfer nip (between the outer peripheral surface of the intermediate transfer belt and the secondary transfer roller), the toner image on the intermediate transfer belt is transferred onto the paper sheet.

When the top edge of a thick paper sheet enters the transfer nip or when the bottom edge thereof exits the transfer nip, the load changes greatly. Therefore, the rotating speed of the intermediate transfer belt fluctuates, or vibration is generated, which might cause streaks or unevenness in the image.

To counter this problem, the nip pressure is temporarily reduced when the top and bottom edges of a paper sheet pass through the transfer nip. For example, in a device disclosed in JP 2010-204259 A, a cam is disposed on the same axis as the shaft of a roller disposed to face a secondary transfer roller with an intermediate transfer belt interposed in between. A protruding portion of the cam is brought into contact with a contact member provided on the shaft of the secondary transfer roller, so that the axis-to-axis distance between the secondary transfer roller and the roller facing the secondary transfer roller is increased, and thus, the nip pressure is temporarily reduced.

In a device disclosed in JP 2017-83503 A, the driving force of a motor is transmitted to a secondary transfer roller through a transmission mechanism, and the secondary transfer roller is pressed against the intermediate transfer belt, while the torque of the motor is controlled, to temporarily reduce pressure. The transmission mechanism of this device includes a first lever and a second lever that are long in a substantially horizontal direction. One end of the first lever is pivotally supported (the point of support), the mid portion thereof pivotally supports the secondary transfer roller (the point of action), and the other end thereof is pivotally supported by a slide hole (the point of action of the second lever) formed at the tip of the second lever. The second lever is pivotally supported at the point of support at a position slightly closer to the front end than the mid point, and the other end thereof is the point of force that receives force from the motor.

Specifically, the other end of the second lever spreads like a fan, and a tooth row to be engaged with a gear disposed on the shaft of the motor is arranged in an arc-like form. The first lever and the second lever form a link mechanism As the second lever swings in accordance with the angle of rotation of the motor shaft, the secondary transfer roller moves up and down. The motor is driven to press the secondary transfer roller against the intermediate transfer belt, and thus, a transfer nip is formed. The secondary transfer roller is in a resting state while the force pushing the secondary transfer roller back from the intermediate transfer belt matches the motor torque. The motor torque is temporarily weakened when the top and bottom edges of a paper sheet pass through the transfer nip. Thus, the nip pressure is reduced.

In the device disclosed in JP 2010-204259 A, a cam and its driver are disposed on the same axis as the shaft of the roller facing the secondary transfer roller with the intermediate transfer belt interposed in between. Therefore, the device configuration is large in the axial direction of the secondary transfer roller.

In the device disclosed in JP 2017-83503 A, the point of action of the pressure reducing mechanism (the second lever) is located outside the point of support and the point of action (the position of the secondary transfer roller) of the pressure mechanism (the first lever). Therefore, the device area in a cross section perpendicular to the shaft of the secondary transfer roller is large.

### SUMMARY

The present invention is to solve the above problem, and an object of the present invention is to provide a secondary transfer device that is smaller in size while having a function of temporarily reducing the nip pressure when the top and bottom edges of a paper sheet pass through the transfer nip.

To achieve the abovementioned object, according to an aspect of the present invention, there is provided a secondary transfer device that performs secondary transfer of a toner image onto a paper sheet at a predetermined secondary transfer position, the toner image having been transferred onto an outer peripheral surface of an intermediate transfer belt through primary transfer, the intermediate transfer belt being stretched around a plurality of rollers, the intermediate transfer belt having an endless annular shape and a predetermined width, and the secondary transfer device reflecting one aspect of the present invention comprises: a pressure releaser that moves a secondary transfer roller between a pressing position for pressing the intermediate transfer belt being nipped between the secondary transfer roller and a counter roller in contact with an inner peripheral surface of the intermediate transfer belt at the secondary transfer position, and a separate position separated from an outer peripheral surface of the intermediate transfer belt; a first driver that drives the pressure releaser; a high-speed pressure reducer that temporarily performs pressure reduction on a nip pressure for the secondary transfer roller at the pressing position to press the intermediate transfer belt being nipped between the secondary transfer roller and the counter roller, when a top edge and a bottom edge of a paper sheet pass through between the secondary transfer roller and the intermediate transfer belt; and a second driver that drives the high-speed pressure reducer, wherein the pressure releaser includes: a pressure cam supported by a rotation shaft that is in the same direction of a shaft of the secondary transfer roller and is driven by the first driver; and a pressure arm that comes into contact with the pressure cam and swings, to move the secondary transfer roller between the pressing position and the separate position, the high-speed pressure reducer includes: a pressure reducing cam supported by a rotation shaft that is in the same direction as the shaft of the secondary transfer roller and is driven by the second driver; and a pressure reducing arm that comes into contact with the pressure reducing cam and swings, to move the secondary transfer roller at the pressing position in such a direction that the nip pressure becomes lower, and a center of an axis of the pressure reducing cam is disposed in a circle having a radius extending from a point of support of the pressure arm to a center of an axis of the pressure cam.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram showing the mechanical configuration of an image forming apparatus including a secondary transfer device according to an embodiment of the present invention;

FIG. 2 is a diagram schematically showing the secondary transfer device that has a transfer nip formed between the secondary transfer device and an intermediate transfer belt;

FIG. 3 is a perspective view of a secondary transfer unit;

FIG. 4 is a right side view of the secondary transfer device (as viewed from the upstream side in the sheet conveyance direction);

FIG. 5 is a diagram schematically showing relevant components of the secondary transfer device during release;

FIG. 6 is a diagram schematically showing relevant components of the secondary transfer device during pressure application;

FIG. 7 is a diagram schematically showing relevant components of the secondary transfer device during pressure reduction;

FIG. 8 is a diagram for explaining the layout of the respective components of the secondary transfer device according to an embodiment of the present invention;

FIG. 9 is a right side view of a secondary transfer device having a configuration in which only one pressure reducing cam is provided at the center in the front-rear direction; and

FIGS. 10A and 10B are diagrams showing a comparison between a normal state and a state in which a lock mechanism is turned off to move rotation shafts.

### DETAILED DESCRIPTION OF EMBODIMENTS

Hereinafter, one or more embodiments of the present invention will be described with reference to the drawings. However, the scope of the invention is not limited to the disclosed embodiments.

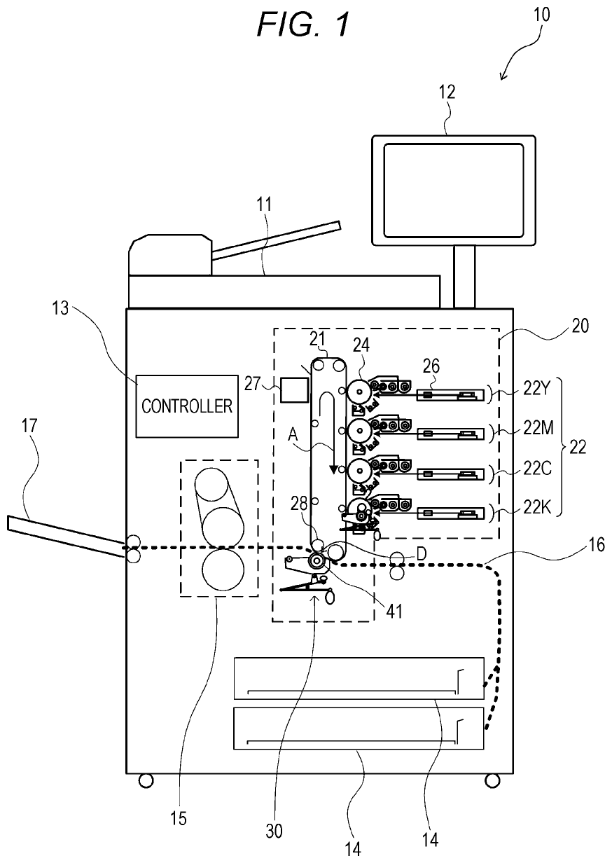

FIG. 1 schematically shows the configuration of an image forming apparatus 10 including a secondary transfer device 30 according to an embodiment of the present invention. The image forming apparatus 10 is a so-called multifunction machine that has a copy function for forming an image obtained by optically reading an original on a recording material such as recording paper and outputting the formed image, a print function for forming an image rasterized on the basis of print data input from outside on recording paper and outputting the formed image, and the like. The recording material is not necessarily recording paper, but may be film or cloth. Hereinafter, the recording material will be described as recording paper.

The image forming apparatus 10 includes: a scanner unit 11 that optically reads a document; an operation panel 12 that receives user operations and displays various kinds of information; a control circuit unit 13 that controls operation of the entire apparatus and performs image processing; an image forming unit 20 that forms an unfixed toner image on a recording material; a fixing device 15 that fixes the unfixed toner image to the recording paper; a sheet feed tray 14 capable of storing a large number of recording paper sheets to be used in image formation; and a conveyance unit 16 that conveys each paper sheet supplied from the sheet feed tray 14.

The image forming unit 20 forms a toner image by an electrophotographic technique. The image forming unit 20 includes: an endless annular intermediate transfer belt 21 that is stretched around a plurality of rollers and has a predetermined width; image formation units 22Y, 22M, 22C, and 22K of the respective colors of yellow (Y), magenta (M), cyan (C), and black (K) that form (perform primary transfer of) toner images in the respective colors onto the outer peripheral surface of the intermediate transfer belt 21; and the secondary transfer device 30 that performs secondary transfer of the toner images formed on the outer peripheral surface of the intermediate transfer belt 21 onto recording paper. Note that the image formation units 22Y, 22M, 22C, and 22K of the respective colors are also collectively referred to as the image formation unit 22.

The image formation units 22Y, 22M, 22C, and 22K have different colors of toner to be used therein, but have the same structure. The image formation units 22Y, 22M, 22C, and 22K each include a cylindrical photosensitive drum 24 as an electrostatic latent image carrier on which an electrostatic latent image is formed, and a charging device, a developing device, a transfer device, a photosensitive cleaning device, and the like disposed around the photosensitive drum 24. Each image formation unit 22 also includes a laser diode (LD) as a laser element, a polygon mirror, and a print head 26 formed with various kinds of lenses, a mirror, and the like.

In each of the image formation units 22Y, 22M, 22C, and 22K, the photosensitive drum 24 is driven by a driver (not shown) to rotate in a certain direction, the charging device uniformly charges the photosensitive drum 24, and the print head 26 scans the photosensitive drum 24 with a laser beam that is on/off controlled in accordance with a drive signal based on image data of the corresponding color. Thus, an electrostatic latent image is formed on the surface of the photosensitive drum 24.

The developing device performs a developing process to develop and visualize the electrostatic latent image on the surface of the photosensitive drum 24 with toner. The toner image formed on the surface of the photosensitive drum 24 is transferred (primary transfer) onto the intermediate transfer belt 21 at a position at which the toner image is brought into contact with the intermediate transfer belt 21. The photosensitive cleaning device removes and collects the toner remaining on the surface of the photosensitive drum 24 by scraping off the remaining toner with a blade or the like after the transfer.

The intermediate transfer belt 21 stretched around the plurality of rollers is driven by a driver (not shown), to rotate in the direction indicated by arrow A in the drawing. In the course of rotation, the toner images formed on the photosensitive drums 24 of the image formation units 22Y, 22M, 22C, and 22K of the respective colors are sequentially transferred onto and superimposed on one another on the intermediate transfer belt 21, so that a full-color image (toner image) is formed on the intermediate transfer belt 21. This toner image is transferred (secondary transfer) from the intermediate transfer belt 21 onto recording paper by the secondary transfer device 30 disposed at the secondary transfer position D. Further, the toner remaining on the intermediate transfer belt 21 after the secondary transfer is removed from the intermediate transfer belt 21 by a cleaning device 27 disposed downstream of the secondary transfer position D.

The fixing device 15 is disposed in the middle of the recording paper conveyance path and downstream of the secondary transfer position D, and fixes the toner image transferred onto the surface of the recording paper at the secondary transfer position D to the recording paper by applying pressure and heat thereto.

The conveyance unit 16 has a function to transfer the recording paper supplied from the sheet feed tray 14 to a sheet catch tray 17 through the secondary transfer position D and the fixing device 15. The conveyance unit 16 includes conveyance rollers and a guide that constitute a conveyance path, a motor that drives the conveyance rollers, and the like. Although not shown in the drawing, the conveyance unit 16 includes a sheet reversing mechanism for double-sided printing that reverses the recording paper conveyed from the fixing device 15, and sends the recording paper back to the conveyance path located upstream of the secondary transfer position D.

The control circuit unit 13 includes a central processing unit (CPU), a read only memory (ROM), a random access memory (RAM), and the like as its principal components. The CPU performs a process according to a program stored in the ROM, to execute each function of the image forming apparatus 10. The control circuit unit 13 controls operations of the conveyance unit 16, the image forming unit 20, the secondary transfer device 30, and the like.

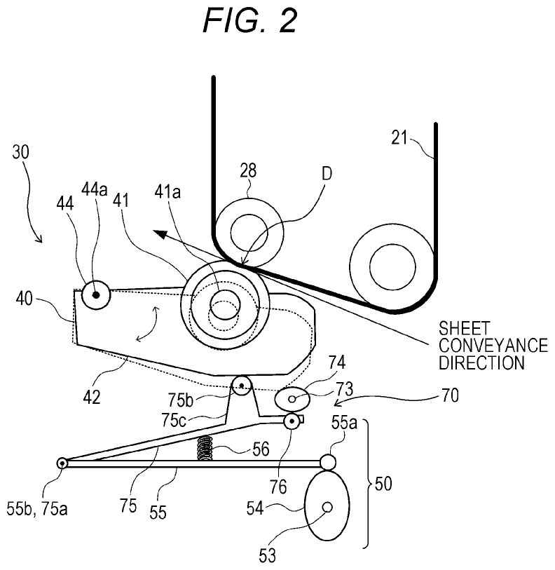

FIG. 2 is a diagram schematically showing the secondary transfer device 30 that has a transfer nip formed between the secondary transfer device 30 and the intermediate transfer belt. The secondary transfer device 30 presses a secondary transfer roller 41 whose axial direction is the width direction of the intermediate transfer belt 21 (the direction orthogonal to the paper surface) against the outer peripheral surface of the intermediate transfer belt 21 at the secondary transfer position D, so that a transfer nip is formed, with the intermediate transfer belt 21 being nipped between the secondary transfer roller 41 and a roller (a counter roller 28) disposed at a portion facing the secondary transfer roller 41 among the rollers around which the intermediate transfer belt 21 is stretched.

Hereinafter, the width direction of the intermediate transfer belt 21 (the axial direction of the secondary transfer roller 41) will be referred to as the “front-rear direction”. Further, any relative position on the edge side in the front-rear direction will be referred to as “outside”, and any relative position closer to the center in the front-rear direction will be referred to as “inside”.

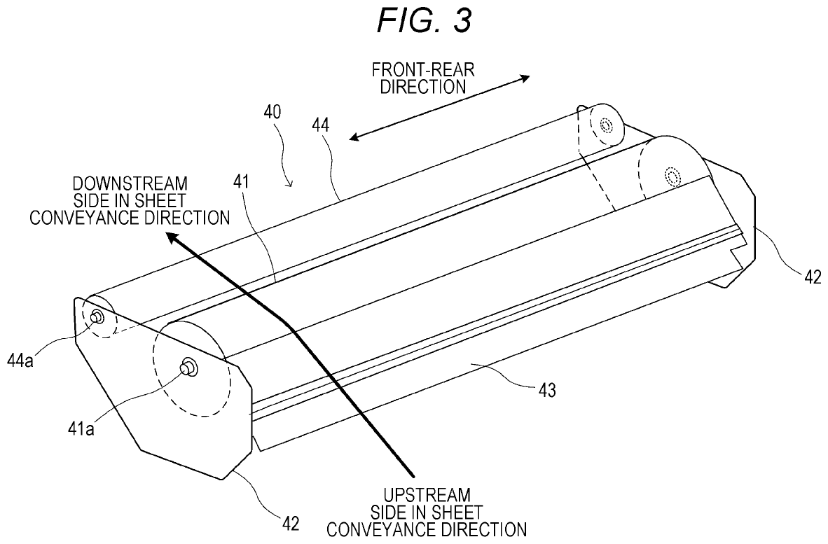

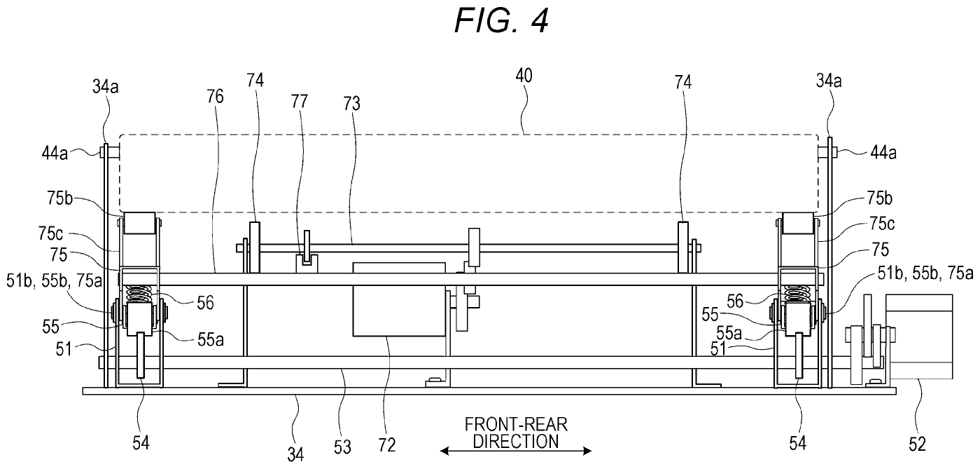

The secondary transfer roller 41 is incorporated into a secondary transfer unit 40 that rotatably supports the secondary transfer roller 41. FIG. 3 is a perspective view of the secondary transfer unit 40. FIG. 4 is a right side view of the secondary transfer device 30 (as viewed from the upstream side in the sheet conveyance direction).

The secondary transfer device 30 includes: the secondary transfer unit 40; a pressure releasing unit (a pressure releaser) 50 that causes the secondary transfer unit 40 to move between a pressing position (a pressed state) at which the secondary transfer roller 41 is pressed against the intermediate transfer belt 21 to form the transfer nip, and a separate position (a released state) at which the secondary transfer roller 41 is separated from the intermediate transfer belt 21; a first driver 52 (see FIG. 4) that drives the pressure releasing unit 50; a high-speed pressure reducing unit (a high-speed pressure reducer) 70 that temporarily reduces the nip pressure of the secondary transfer roller 41 pressing the intermediate transfer belt 21 between the secondary transfer roller 41 and the counter roller 28 at the pressing position, when the top edge and the bottom edge of a paper sheet pass through the secondary transfer position D (between the secondary transfer roller 41 and the intermediate transfer belt 21); and a second driver 72 (see FIG. 4) that drives the high-speed pressure reducing unit 70. The pressure releasing unit 50 and the high-speed pressure reducing unit 70 are formed as components independent of the secondary transfer unit 40.

The secondary transfer device 30 includes a substantially rectangular flat frame member 34 that is long in the front-rear direction (see FIG. 4). The secondary transfer unit 40, the pressure releasing unit 50, the high-speed pressure reducing unit 70, the first driver 52, and the second driver 72 are attached to the frame member 34.

As shown in FIG. 3, the secondaiy transfer unit 40 includes a frame member 42 formed with right and left side panels and the like, and the secondary transfer roller 41 is rotatably supported by the frame member 42. A guide panel 43 that guides paper sheets to the transfer nip, a separation roller 44 that separates each paper sheet from the intermediate transfer belt 21 after the secondary transfer, and the like are attached to the frame member 42. The separation roller 44 is disposed at a position that is at a predetermined distance from the shaft 41a of the secondary transfer roller 41 toward the downstream side in the sheet conveyance direction.

In the secondary transfer unit 40, the shaft 44a of the separation roller 44 is supported at both ends by a pair of holding panels 34a that stand from the vicinities of both ends of the frame member 34 in the front-rear direction and face each other, and the secondary transfer unit 40 swings around the shaft 44a serving as a center of rotation (see FIG. 4).

The pressure releasing unit 50 includes: pressure cams 54 that rotate while being supported by a rotation shaft 53 that extends in the same direction as the shaft 41a of the secondary transfer roller 41 and is driven by the first driver 52; and pressure arms 55 that come into contact with the pressure cams 54 and swing the pressure cams 54, to move the secondary transfer unit 40 between the pressing position (the pressed state) and the separate position (the released state).

Contact rollers 55a that are in contact with the pressure cams 54 are pivotally supported at the tips of the pressure arms 55. The other ends of the pressure arms 55 serve as rotation fulcrums 55b of the pressure arms 55, and are pivotally supported by support panels 51 standing on the frame member 34 via support shafts 51b (see FIG. 4). The pressure arms 55 are oriented such that the contact rollers 55a at the front ends are located on the upstream side in the sheet conveyance direction, and the rotation fulcrums 55b at the rear ends are located on the downstream side in the sheet conveyance direction. The axial direction of the rotation fulcrums 55b is the same as the direction of the shaft 41a of the secondary transfer roller 41. Springs 56 that extend spirally upward are attached to predetermined portions between the front end and the rear ends of the pressure arms 55.

The high-speed pressure reducing unit 70 includes: a rotation shaft 73 that extends in the same direction as the shaft 41a of the secondary transfer roller 41 and is driven by the second driver 72; pressure reducing cams 74 that are attached to the rotation shaft 73 and rotate; and pressure reducing arms 75 that come into contact with the pressure reducing cams 74 and swing to move the secondary transfer unit 40 at the pressing position in such a direction that the nip pressure becomes lower.

A rotator (the connecting shaft described later) 76 is pivotally supported at the tips of the pressure reducing arms 75, and the rotator 76 is brought into contact with the pressure reducing cams 74. The pressure reducing arms 75 are supported at the rear ends by the support shafts 51b. These portions serve the rotation fulcrums 75a of the pressure reducing arms 75. The pressure reducing arms 75 are also pivotally supported at the same positions as the pressure arms 55 in the axial direction of the support shafts 51b.

The pressure reducing arms 75 have arm portions 75c extending upward at predetermined locations near the front ends, and the top ends of the arm portions 75c pivotally support pressing rollers 75b that are brought into contact with the secondary transfer unit 40 from below. The top ends of the springs 56 provided on the pressure arms 55 are brought into contact with the pressure reducing arms 75 from below.

In the pressure arms 55, the portions of the contact rollers 55a are the points of force that receive force from the pressure cams 54, the portions pivotally supported by the support shafts 51b are the rotation fulcrums 55b, and the portions to which the springs 56 are attached are the points of action at which upward force is applied to the pressure reducing arms 75 via the springs 56. In the pressure reducing arms 75, the pivotally supported portions of the rotator 76 are the points of force that receive force from the pressure reducing cams 74 via the rotator 76, the portions pivotally supported by the support shafts 51b are the rotation fulcrums 75a, and the contact portions at the top ends of the springs 56 are the points of action during pressure reduction.

The pressure arms 55 swing around the rotation fulcrums 55b, and, to form the transfer nip, push the secondary transfer unit 40 upward from below through the springs 56 and the pressure reducing arms 75 in this order. In response to this, the secondary transfer unit 40 swings around the shaft 44a, and the secondary transfer roller 41 is pressed against the counter roller 28. To reduce pressure, the pressure reducing arms 75 push the springs 56 back toward the pressure arms 55.

As shown in FIG. 4, the pressure cams 54, the pressure arms 55, and the pressure reducing arms 75 are disposed in the vicinities of both ends of the secondary transfer device 30 in the front-rear direction. The two pressure cams 54 disposed separately at both ends in the front-rear direction are in the same phase, and the pressure arms 55 at both ends concurrently apply the same pressure to the bottom surface of the secondary transfer unit 40 via the springs 56 and the pressure reducing arms 75 at both ends in the front-rear direction, and also stop the application of pressure.

The above rotator 76 is a cylindrical connecting shaft 76 that connects the pressure reducing arms 75 disposed at both ends in the front-rear direction to each other, and causes the two pressure reducing arms 75 to interlock with each other. The pressure reducing cams 74 are disposed near the insides of the two pressure reducing arms 75 located separately at both ends in the front-rear direction. When the connecting shaft 76 comes into contact with each of the pressure reducing cams 74, the pressure reducing arms 75 swing around the rotation fulcrums 75a. As the connecting shaft 76 is a rotator that can rotate (revolve), contact resistance with the pressure reducing cams 74 is low, and wear of the pressure reducing cams 74 is reduced accordingly.

The second driver 72 (a motor or the like) that rotates the rotation shaft 73 of the pressure reducing cams 74, and a position detecting sensor 77 that detects the angular positions of the pressure reducing cams 74 are disposed on the inner sides of the two pressure reducing cams 74 disposed separately at both ends in the front-rear direction.

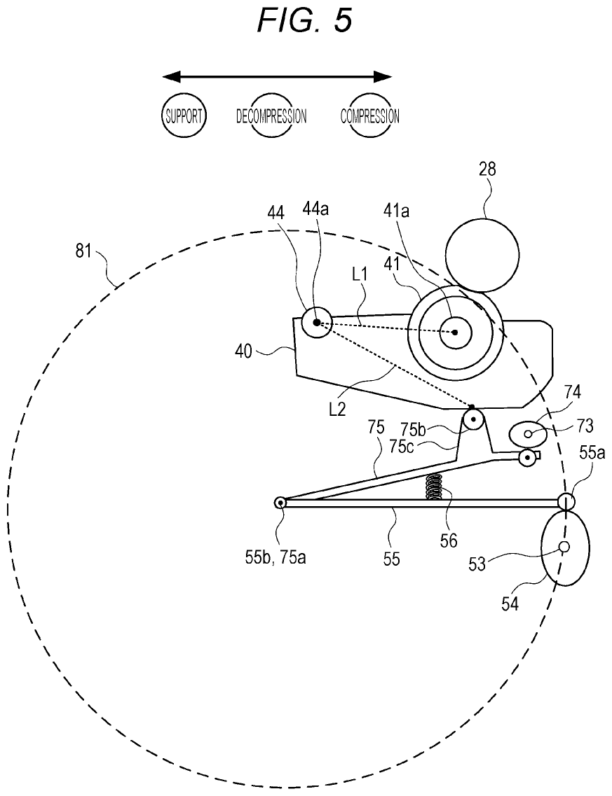

FIG. 5 is a diagram for explaining the layout of the respective components of the secondary transfer device 30. The points of support (the rotation fulcrums 55b) of the pressure arms 55 and the points of support (the rotation fulcrums 75a) of the pressure reducing arms 75 are coaxial and are located at the same positions. The pressure arms 55 are longer than the pressure reducing arms 75. Each of the pressure reducing cams 74 is disposed in a circle having a radius that extends from each of the rotation fulcrums 55b of the pressure arms 55 to the center of the shaft of each of the pressure cams 54. That is, the pressure reducing cams 74 are disposed on the inner side of a circle 81 indicated by a dashed line in FIG. 5.

Also, the pressure reducing cams 74 are disposed between the center of rotation (the shaft 44a of the separation roller 44) of the secondary transfer unit 40 and the pressure cams 54.

The distance L2 between the center of rotation (the shaft 44a) of the secondary transfer unit 40 and the portion at which the secondary transfer unit 40 receives pressing force from the pressure releasing unit 50 (the portion at which the pressing rollers 75b attached to the pressure reducing arms 75 are brought into contact with the bottom surface of the secondary transfer unit 40) is longer than the distance L1 between the center of rotation (the shaft 44a) of the secondary transfer unit 40 and the shaft of the secondary transfer roller 41.

Next, operation of the secondary transfer device 30 is described.

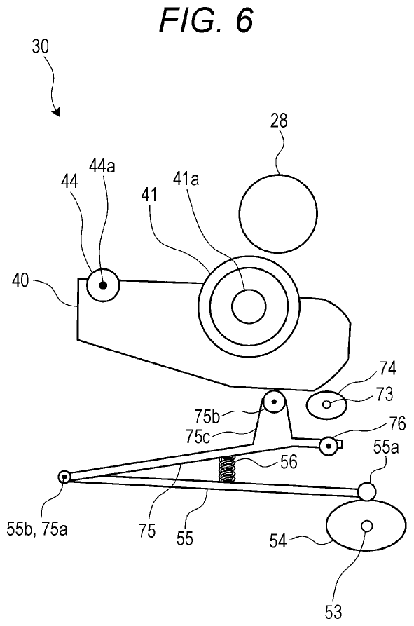

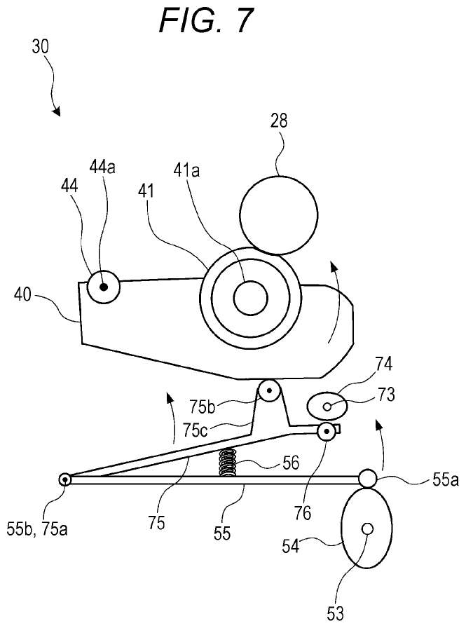

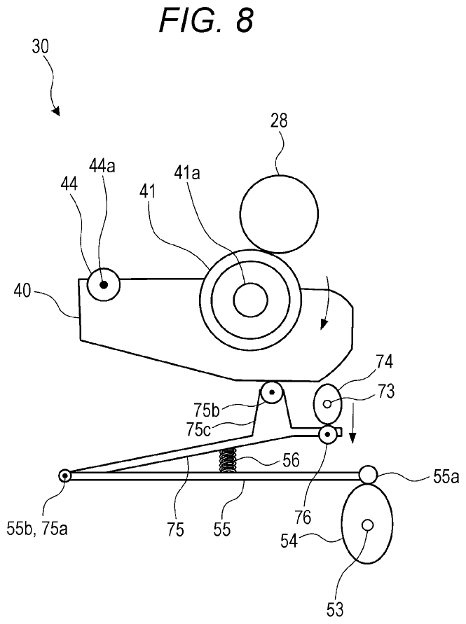

FIG. 6 shows a state in which the secondary transfer unit 40 is at a separate position (a released state). FIG. 7 shows a state in which the secondary transfer unit 40 is at a pressing position (a pressed state). FIG. 8 shows a state in which the high-speed pressure reducing unit 70 has operated to reduce the nip pressure (a pressure-reduced state).

When the secondary transfer device 30 causes the first driver 52 to rotate the rotation shaft 53 of the pressure releasing unit 50, the pressure cams 54 attached to the rotation shaft 53 rotates, and the contact rollers 55a at the tips of the pressure arms 55 are brought into contact with the pressure cams 54, so that the pressure arms 55 swing around the rotation fulcrums 55b in accordance with the angular positions of the pressure cams 54.

When the secondary transfer unit 40 is moved from a separate position (a released state) to a pressing position (a pressed state), the pressure arms 55 rotate a predetermined angle counterclockwise from the position shown in FIG. 6, and press the bottom portion of the secondary transfer unit 40 against the counter roller 28, through the springs 56 and the pressure reducing arms 75 in this order. FIG. 7 shows a pressed state in which the secondary transfer unit 40 has moved to the pressing position, and the high-speed pressure reducing unit 70 is not reducing pressure.

In the pressed state shown in FIG. 7, the pressure reducing cams 74 are at angular positions at which the pressure reducing cams 74 are not in contact with the connecting shaft (rotator) 76. Accordingly, in the pressed state, the pressure reducing arms 75 do not receive any force from the pressure reducing cams 74 via the connecting shaft 76, and are moved in accordance with a pressing operation of the pressure releasing unit 50.

When the pressure reducing cams 74 of the high-speed pressure reducing unit 70 are rotationally moved to predetermined angular positions while the pressure cams 54 of the pressure releasing unit 50 are held at the positions shown in FIG. 7, the pressure reducing cams 74 are brought into contact with the connecting shaft 76 and push down the connecting shaft 76. Accordingly, the pressure reducing arms 75 rotate clockwise about the rotation fulcrums 75a, to push the springs 56 back toward the pressure arms 55 from above, as shown in FIG. 8.

That is, the pressure reducing arms 75 reduces the nip pressure by blocking the pressing force being applied to the secondary transfer unit 40 via the springs 56 by the pressure arms 55. At this stage, the axis-to-axis distance between the counter roller 28 and the secondary transfer roller 41 is shorter by a certain amount than the sum of the radius of the counter roller 28 and the radius of the secondary transfer roller 41 in a non-contact state, and the nip pressure is generated by the elasticity of the outer peripheral materials of the secondary transfer roller 41 and the counter roller 28.

As shown in FIGS. 7 and 8, in a state in which the secondary transfer unit 40 is moved to the pressing position by the pressure releasing unit 50 (a pressed state), a range of motion is secured for the pressure reducing cams 74 so that the pressure reducing cams 74 can rotatably move to the pressure reducing position (the position shown in FIG. 8) and the non-reducing position (the position shown in FIG. 7), without coming into contact with the secondary transfer unit 40. On the other hand, in a state in which the secondary transfer roller 41 is moved to the separate position by the pressure releasing unit 50 (a released state) as shown in FIG. 6, the pressure reducing cams 74 come into contact with the secondary transfer unit 40 unless the pressure reducing cams 74 are located at particular angular positions, and the range of motion is not secured for the pressure reducing cams 74.

In the released state, the secondary transfer unit 40 descends and approaches the pressure reducing cams 74. Therefore, if the range of motion is to be secured for the pressure reducing cams 74 in this state, it is necessary to dispose the secondary transfer unit 40 at a distance from the pressure reducing cams 74, and form notches for preventing contact of the portions corresponding to the pressure reducing cams 74 with the secondary transfer unit 40. As a result, the device will become large in size, and the designing the device will become difficult.

In the released state, on the other hand, there is no need to switch between pressure reduction and no pressure reduction in the first place, and it is not necessary to cause the pressure reducing cams 74 to rotate. Therefore, in the pressed state, the range of motion for the pressure reducing cams 74 is secured so that it is possible to switch between pressure reduction and no pressure reduction. In the released state, the range of motion is not secured for the pressure reducing cams 74, and the pressure reducing cams 74 are not in contact with the secondary transfer unit 40 only at particular angular positions (home positions, for example). Thus, the device can be made smaller in size.

In the secondary transfer device 30 according to this embodiment of the present invention, a pressure-reduced state is temporarily formed by the high-speed pressure reducing unit 70, which is a mechanism independent of the pressure releasing unit 50. Accordingly, it is possible to switch between pressure reduction and no pressure reduction quickly at accurate timing. In a case where the pressure arms 55 are moved back to the separate position from a pressed state to reduce pressure, it is necessary to move the pressure arms 55 so greatly that the springs 56 are fully extended. On the other hand, the secondary transfer device 30 according to this embodiment of the present invention forms a pressure-reduced state by pushing the springs 56 back to the pressure arms 55 with the pressure reducing arms 75. Accordingly, the secondary transfer device 30 can perform a pressure reducing operation while maintaining the pressure arms 55 at the position of the pressed state, and temporarily reduce pressure quickly and smoothly with a small number of moving strokes of the pressure reducing arms 75.

The control circuit unit 13 controls the second driver 72 of the high-speed pressure reducing unit 70 so that pressure is temporarily reduced when the top and bottom edges of a paper sheet pass through the secondary transfer position D. Specifically, a sensor that detects the top and bottom edges of a paper sheet is disposed slightly upstream of the secondary transfer position D in the sheet conveyance direction, and, on the basis of the timing when this sensor detects the top and bottom edges of a paper sheet, the angular positions of the pressure reducing cams 74 are controlled by the second driver 72 so that a pressure-reduced state is formed during a predetermined period before and after the top and bottom edges of the paper sheet pass through the secondary transfer position D.

The features and the effects of the configuration of the secondary transfer device 30 according to this embodiment are now described. As shown in FIG. 5, the secondary transfer device 30 is characterized in that the pressure reducing cams 74 are disposed between the points of support (the rotation fulcrums 55b) of the pressure arms 55 and the pressure cams 54 (or in a circle having a radius extending from the rotation fulcrums 55b of the pressure arms 55 to the center of the shaft of the pressure cams 54). With this arrangement, the high-speed pressure reducing unit 70 can be accommodated in a space in the pressure releasing unit 50, and an increase in the space due to the addition of the high-speed pressure reducer can be prevented.

Further, the points of support (the rotation fulcrums 55b) of the pressure arms 55 and the points of support (the rotation fulcrums 75a) of the pressure reducing arms 75 are set at the same position (located on the same axis and at the same position in the axial direction). Accordingly, the operating regions of the pressure arms 55 overlap the operation regions of the pressure reducing arms 75. Thus, the device can be made smaller in size.

The secondary transfer device 30 is also characterized in that the pressure releasing unit 50 and the high-speed pressure reducing unit 70 are disposed below the secondary transfer unit 40. With this arrangement, the pressure releasing unit 50 and the high-speed pressure reducing unit 70 can be disposed in a free space, without competing, in terms of space, with a resist mechanism located on the upstream side of the secondary transfer device 30 in the sheet conveyance direction and the fixing device 15 located on the downstream side in the sheet conveyance direction, and thus, contribute to size reduction of the entire image forming unit 20.

Further, as shown in FIG. 4, the secondary transfer device 30 is characterized in that the pressure arms 55 and the pressure cams 54 are disposed at two separate portions that are the two ends in the front-rear direction, and the high-speed pressure reducing unit 70 (particularly, the pressure reducing cams 74) is disposed on the inner sides of the pressure arms 55 and the pressure cams 54. With this arrangement, the size of the device in the front-rear direction can be made smaller than in a case where the high-speed pressure reducing unit 70 is disposed on the outer sides of the pressure cams 54.

The secondary transfer device 30 is also characterized in that, like the pressure arms 55 and the pressure cams 54, the pressure reducing arms 75 are disposed at both ends in the front-rear direction, the pressure reducing arms 75 are connected to each other by the connecting shaft 76, and the pressure reducing cams 74 are disposed near the inner sides of the respective pressure cams 54. With this arrangement, each of the pressure reducing cams 74 can apply force for pressure reduction to the connecting shaft 76 near the pressure reducing arms 75, and can reduce bending of the connecting shaft 76.

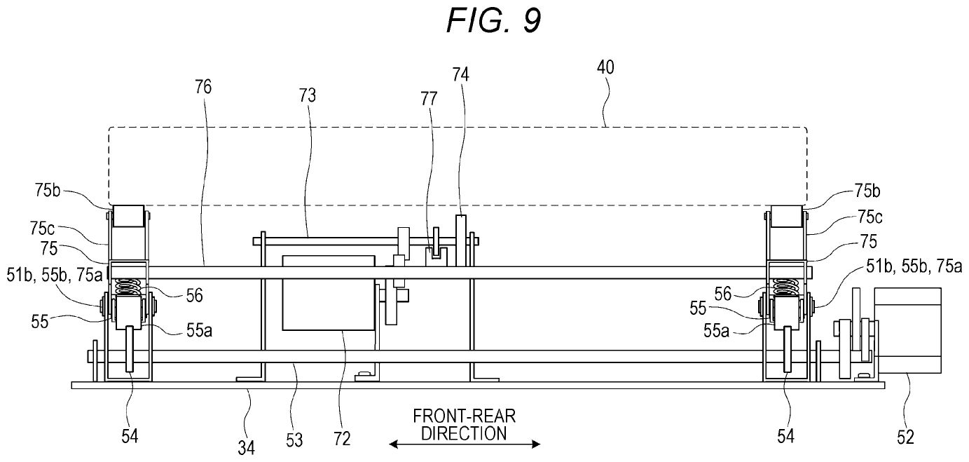

As shown in FIG. 9, only one pressure reducing cam 74 may be disposed on the inner sides of the pressure cams 54 provided separately at both ends in the front-rear direction, and at the center in the front-rear direction. In a case where the pressure reducing cams 74 are provided at two locations separated in the front-rear direction as shown in FIG. 4, there is a possibility that a difference will be generated in the pressure reducing operation between the two pressure reducing arms 75 at both ends, due to the cam shape, a phase shift, or the like. On the other hand, in a configuration in which a pressure reducing cam 74 is disposed only at one location at the center in the front-rear direction as shown in FIG. 9, the pressure reducing arms 75 at both ends can be synchronized with each other to perform a pressure reducing operation.

As shown in FIG. 4, the secondary transfer device 30 is also characterized in that the position detecting sensor 77 that detects the angular positions of the second driver 72 and the pressure reducing cam 74 is disposed on the inner sides of the two pressure cams 54 separated at both ends in the front-rear direction. With this arrangement, the size of the secondary transfer device 30 in the front-rear direction is reduced. In a configuration having only one pressure reducing cam 74 as shown in FIG. 9, the second driver 72 and the position detecting sensor 77 are also disposed on the inner sides of the two pressure cams 54 separated at the two ends in the front-rear direction, and thus, the size of the secondary transfer device 30 in the front-rear direction is reduced.

The secondary transfer device 30 is also characterized in that the pressure reducing cams 74 are disposed between the center of rotation (the shaft 44a of the separation roller 44) of the secondary transfer unit 40 and the pressure cams 54. With this arrangement, the pressure reducing cams 74 can be accommodated in the space (between the center of rotation of the secondary transfer unit 40 and the pressure cams 54) required for the pressure releasing unit 50 to move the secondary transfer unit 40. Thus, the increase in the occupied space due to the addition of the high-speed pressure reducing unit 70 is prevented.

Further, as the secondary transfer roller 41 is incorporated into the secondary transfer unit 40 to form a unit, the size, the maintainability, and the exchangeability of the high-speed pressure reducing unit 70 are improved. Furthermore, as the pressure releasing unit 50 and the high-speed pressure reducing unit 70 are independent of the secondary transfer unit 40, the secondary transfer unit 40 is less complicated, and the entire secondary transfer device 30 can be made simpler than in a case where some of the components relating to the pressure releasing unit 50 and the high-speed pressure reducing unit 70 are incorporated into the secondary transfer unit 40.

The secondary transfer device 30 is also characterized in that the shaft 44a of the separation roller 44 also serves as the center of rotation of the secondary transfer unit 40. With this arrangement, the position of the separation roller 44 is fixed irrespective of swinging and moving of the secondary transfer unit 40, and the transfer of a paper sheet from the separation roller 44 to the downstream conveyance path is stabilized.

The secondary transfer device 30 is also characterized in that the distance L2 between the center of rotation of the secondary transfer unit 40 and the portion at which the secondary transfer unit 40 receives pressing force from the pressure releasing unit 50 (the portion of contact with the pressing rollers 75b) is longer than the distance L1 (see FIG. 5) between the center of rotation (the shaft 44a of the separation roller 44) of the secondary transfer unit 40 and the shaft of the secondary transfer roller 41. With this arrangement, the pressing force of the pressure releasing unit 50 is increased by the lever ratio and acts on the secondary transfer unit 40, and the torque required for the pressure releasing unit 50 and the high-speed pressure reducing unit 70 becomes smaller. Thus, the motor and the like are made smaller in size, and costs are lowered. In particular, in a configuration in which the pressure releasing unit 50 applies pressing force to the secondary transfer unit 40 via the springs 56, the springs 56 having a low repulsive force can be used depending on the lever ratio. As the springs 56 having a low repulsive force are used, the amount of force required for the high-speed pressure reducing unit 70 to push back the springs 56 in a pressure reducing operation becomes smaller. Thus, the second driver 72 can be made smaller in size, and costs can be lowered.

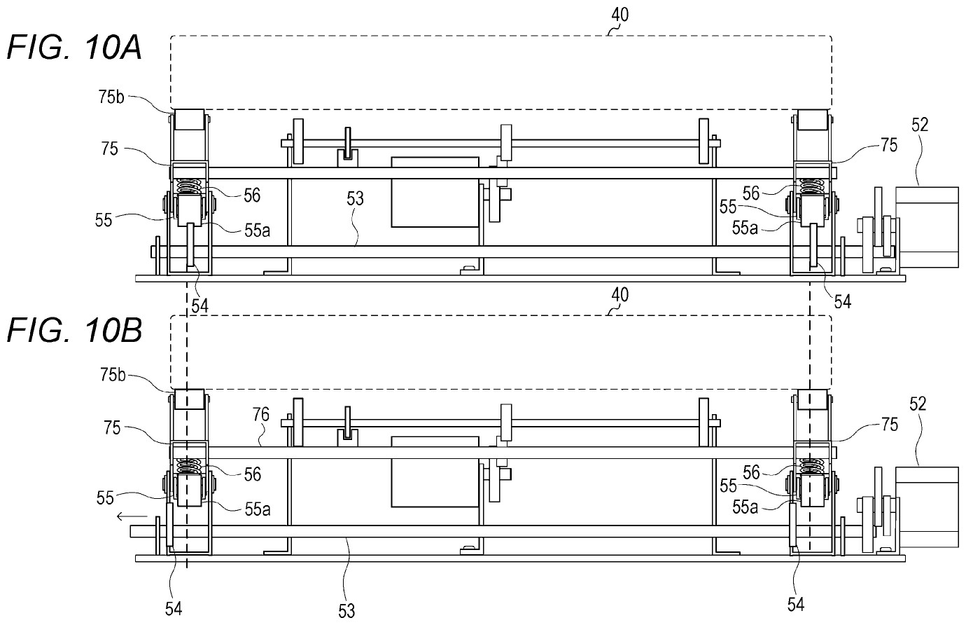

In addition to the above, in the secondary transfer device 30, a lock mechanism (not shown) is turned off, to enable the rotation shaft 53 of the pressure cams 54 to move in the axial direction, and this movement changes the positions of the pressure cams 54 and the contact rollers 55a of the pressure arms 55. Thus, the engagement between these components is cancelled. FIG. 10A shows a normal usage state in which the lock mechanism is on. FIG. 10B shows a state in which the lock mechanism is off, and the rotation shaft 53 is moved in the axial direction to cancel the above-mentioned engagement. In this case, the pressure cams 54 and the contact rollers 55a of the pressure arms 55 are displaced and disengaged, so that the pressure arms 55 (and the pressure reducing arms 75) are put into in the released state as shown in FIG. 6.

For example, in a case where the secondary transfer device 30 is stopped in a pressed state or a pressure-reduced state due to some trouble, the lock mechanism is manually turned off, and the rotation shaft 53 is slightly moved in the axial direction, so that the pressed state or the pressure-reduced state can be cancelled, and removal of a jammed paper sheet or the like can be smoothly performed.

Although an embodiment of the present invention has been described so far with reference to the accompanying drawings, specific configurations are not limited to the embodiment, and modifications and additions within the scope of the invention are included in the present invention.

The secondary transfer roller 41 is not necessarily incorporated into the secondary transfer unit 40. For example, the pressure releasing unit 50 may push the shaft of the secondary transfer roller 41, to form a pressed state.

In the embodiment, the pressure arms 55 push the secondary transfer unit 40 via the springs 56 and the pressure reducing arms 75 during pressure application, and the pressure reducing arms 75 push back the springs 56 during pressure reduction. However, the pressure arms 55 may push the secondary transfer unit 40 via the springs 56, and the pressure reducing arms 75 may engage with hooks formed at both ends of the secondary transfer unit 40, and move the secondary transfer unit 40 toward the separate position by a small amount, to reduce pressure. The shape of the springs 56 is not limited to the shape illustrated in the embodiment, and the springs 56 may be leaf springs or the like, as long as they are elastic members having necessary elasticity.

In the embodiment, the pressure cams 54, the pressure arms 55, the pressure reducing cams 74, the pressure reducing arms 75, and the like are schematically illustrated, and the shapes and the like thereof are not limited to those described in the embodiment. For example, if arms that extend downward are attached to the tips of the pressure reducing arms 75, and the lower ends of the arms are connected to the connecting shaft 76, the position of the pressure reducing cams 74 can be made lower, and the size can be reduced.

Although embodiments of the present invention have been described and illustrated in detail, the disclosed embodiments are made for purposes of illustration and example only and not limitation. The scope of the present invention should be interpreted by terms of the appended claims.

What is claimed is:

1. A secondary transfer device that performs secondary transfer of a toner image onto a paper sheet at a predetermined secondary transfer position, the toner image having been transferred onto an outer peripheral surface of an intermediate transfer belt through primary transfer, the intermediate transfer belt being stretched around a plurality of rollers, the intermediate transfer belt having an endless annular shape and a predetermined width,
the secondary transfer device comprising:
a pressure releaser that moves a secondary transfer roller between a pressing position for pressing the intermediate transfer belt being nipped between the secondary transfer roller and a counter roller in contact with an inner peripheral surface of the intermediate transfer belt at the secondary transfer position, and a separate position separated from an outer peripheral surface of the intermediate transfer belt;
a first driver that drives the pressure releaser;
a high-speed pressure reducer that temporarily performs pressure reduction on a nip pressure for the secondary transfer roller at the pressing position to press the intermediate transfer belt being nipped between the secondary transfer roller and the counter roller, when a top edge and a bottom edge of a paper sheet pass through between the secondary transfer roller and the intermediate transfer belt; and
a second driver that drives the high-speed pressure reducer, wherein
the pressure releaser includes: a pressure cam supported by a rotation shaft that is in the same direction of a shaft of the secondary transfer roller and is driven by the first driver; and a pressure arm that comes into contact with the pressure cam and swings, to move the secondary transfer roller between the pressing position and the separate position,
the high-speed pressure reducer includes: a pressure reducing cam supported by a rotation shaft that is in the same direction as the shaft of the secondary transfer roller and is driven by the second driver; and a pressure reducing arm that comes into contact with the pressure reducing cam and swings, to move the secondary transfer roller at the pressing position in such a direction that the nip pressure becomes lower, and
a center of an axis of the pressure reducing cam is disposed in a circle having a radius extending from a point of support of the pressure arm to a center of an axis of the pressure cam.

2. The secondary transfer device according to claim 1, wherein
the point of support of the pressure arm is coaxial with and at the same position as a point of support of the pressure reducing arm.

3. The secondary transfer device according to claim 1, wherein
the secondary transfer roller is included in a secondary transfer unit, and
the pressure releaser and the high-speed pressure reducer are independent of the secondary transfer unit.

4. The secondary transfer device according to claim 3, wherein
the pressure arm pushes the secondary transfer unit via a spring and the pressure reducing arm in this order, and
the high-speed pressure reducer pushes the spring back toward the pressure arm with the pressure reducing arm, to perform the pressure reduction.

5. The secondary transfer device according to claim 3, wherein,
in a state in which the secondary transfer roller is set at the pressing position by the pressure releaser, a range of motion is secured for the pressure reducing cam to move between a position at which the pressure reduction is performed without the pressure reducing cam being brought into contact with the secondary transfer unit, and a position at which the pressure reduction is not performed, and,
in a state in which the secondary transfer roller is set at the separate position by the pressure releaser, the range of motion is not secured for the pressure reducing cam, and the pressure reducing cam does not come into contact with the secondary transfer unit only at a particular angular position.

6. The secondary transfer device according to claim 3, wherein
the pressure releaser and the high-speed pressure reducer are disposed below the secondary transfer unit.

7. The secondary transfer device according to claim 3, wherein
the secondary transfer unit swings around a center of rotation, and
the pressure reducing cam is disposed between the center of rotation of the secondary transfer unit and the pressure cam.

8. The secondary transfer device according to claim 3, wherein
the secondary transfer unit swings around a center of rotation, and
a shaft of a separation roller that separates the paper sheet after the secondary transfer from the intermediate transfer belt also serves as the center of rotation of the secondary transfer unit.

9. The secondary transfer device according to claim 3, wherein
a distance between a center of rotation of the secondary transfer unit and a point at which the secondary transfer unit receives a pressing force from the pressure releaser is longer than a distance between the center of rotation of the secondary transfer unit and the secondary transfer roller.

10. The secondary transfer device according to claim 1, wherein
the pressure reducing cam comes into contact with a rotator pivotally supported by the pressure reducing arm.

11. The secondary transfer device according to claim 1, wherein
the pressure arm and the pressure cam are provided at each of two locations separated at both ends in an axial direction of the secondary transfer roller, and the high-speed pressure reducer is disposed on inner sides of the pressure arms and the pressure cams.

12. The secondary transfer device according to claim 11, wherein
the pressure reducing arm is provided at each of two locations separated at both ends in the axial direction of the secondary transfer roller, and the pressure reducing arms are connected by a connector,
the pressure reducing cam is disposed at a center in the axial direction of the secondary transfer roller, and
the connector comes into contact with the pressure reducing cam, to cause the pressure reducing arm to swing.

13. The secondary transfer device according to claim 11, wherein
the pressure reducing arm is provided at each of two locations separated at both ends in the axial direction of the secondary transfer roller, and the pressure reducing arms are connected by a connector,
the pressure reducing cam is provided near an inner side of each of the pressure cams, and
the connector comes into contact with the pressure reducing cam, to cause the pressure reducing arm to swing.

14. The secondary transfer device according to claim 11, wherein
a position detector that detects angular positions of the second driver and the pressure reducing cam is disposed on inner sides of the two pressure cams provided separately at both ends in the axial direction of the secondary transfer roller.

15. The secondary transfer device according to claim 1, wherein
a rotation shaft of the pressure cam is enabled to move in an axial direction when a lock mechanism is turned off, and engagement between the pressure cam and a contactor on a side of the pressure arm is canceled by the pressure cam moving.
